(19) United States
(12) Patent Application Publication
(10) Pub. No.: US 2016/0152737 A1
(43) Pub. Date: Jun. 2, 2016

(54) TWO STAGE CONTINUOUS STEAM PRE-TREATMENT OF LIGNOCELLULOSIC BIOMASS

(71) Applicant: GREENFIELD SPECIALTY ALCOHOLS INC., Toronto (CA)

(72) Inventors: Frank A. DOTTORI, Temiscaming (CA); Robert Ashley Cooper BENSON, North Bay (CA); Régis-Olivier BENECH, Chatham (CA)

(21) Appl. No.: 15/013,550

(22) Filed: Feb. 2, 2016

Related U.S. Application Data
(63) Continuation-in-part of application No. 13/554,601, filed on Jul. 20, 2012, now Pat. No. 9,255,189.
(60) Provisional application No. 61/512,723, filed on Jul. 28, 2011.

(51) Int. Cl. C08B 37/00

(52) U.S. Cl. CPC C08B 37/0057

(57) ABSTRACT

Disclosed is a method of steam explosion pretreating biomass in a two stage steam pretreatment process for improved carbohydrate fractionation. The first stage steam pretreatment is carried out by heating the biomass to a first stage temperature of 140° C. to 180° C. for a first stage time of 30 minutes to 2 hours at a first stage pressure of 105 to 150 psig. The second stage steam pretreatment is carried out by heating the biomass to a second stage temperature of 190° C. to 210° C. for a second stage time of 2 to 10 minutes at a second stage pressure of 167 to 262 psig. The biomass may be initially conditioned by atmospheric steam heating and adjusting the moisture content of the biomass. Hemicellulose sugars and inhibitors (inhibitory compounds) to downstream hydrolysis and fermentation are preferably removed between the first and second steam pretreating stages, more preferably after each steam pretreatment stage.

### CROSS REFERENCE TO RELATED APPLICATIONS

This application is a Continuation in Part of Application U.S. Ser. No. 13/554,601, filed Jul. 20, 2012 and entitled Ethanol Production With Two Stage Continuous Steam Pre-Treatment Of Lignocellulosic Biomass, which claims the benefit of priority of U.S. Provisional Patent Application No. 61/512,723, filed Jul. 28, 2011, which are both incorporated herein by reference in their entirety.

### FIELD OF THE INVENTION

The invention relates to the preparation of lignocellulosic biomass to enable fractionation of carbohydrates and in particular to a continuous pretreatment process of lignocellulosic biomass for the fractionation of carbohydrates.

### BACKGROUND AND DESCRIPTION OF PRIOR ART

There is a growing demand for transportation fuels made from renewable feedstocks. These renewable fuels displace fossil fuels resulting in a reduction of greenhouse gas emissions, along with other benefits (1-3).

In North America fuel ethanol is the major transportation fuel. Ethanol is generally manufactured by fermentation of biomass derived carbohydrates. The feedstock for fuel ethanol in North America is primarily corn. Corn contains starch which is hydrolyses to glucose and then fermented to ethanol. In other countries, such as Brazil, fuel ethanol is made by fermenting the sugar in sugar cane. It is advantageous to have an additional source of sugars like glucose to make additional biofuels (4-10).

At the other end of the spectrum of difficulty is cellulose. Cellulose is one of the most abundant organic materials on earth. It is present in many forms of biomass, including agricultural residues like corn Stover and corncobs, woody residues and other plant materials. Cellulose is a polymer of glucose, as is starch.

Lignocellulosic biomass is composed of three primary polymers that make up plant cell walls: Cellulose, hemicellulose, and lignin. Cellulose fibers are locked into a rigid structure of hemicellulose and lignin. Lignin and hemicelluloses form chemically linked complexes that bind water soluble hemicelluloses into a three dimensional array, cemented together by lignin. Lignin covers the cellulose microfibrils and protects them from enzymatic and chemical degradation. These polymers provide plant cell walls with strength and resistance to degradation, which makes lignocellulosic biomass a challenge to use as substrate for biofuel production (11).

One of the aims of conventional pretreatment processes is the maximizing of the overall value of components derived from lignocellulosic biomass. Purified cellulose is valuable for many purposes purified cellulose can be used to make viscous fibers for textiles, cellophane and many other cellulose based chemical products such as CMC, HEC, MCCetc. Specifically, when purified, it may also be more easily hydrolyzed to glucose, which in turn may be more easily fermented to ethanol than in previous processes. Hemicellulose has value as a feedstock for the production of ethanol and also as a precursor to the production of other materials such as xylitol, bioactive food ingredients and plastics. Lignin can be recovered and used as the base for a wide number of industrial chemicals such as dispersants, binders, carbonized films, and phenol replacements. An important step in the successful conversion of lignocellulosics to chemicals is the conditioning and pretreatment of the biomass to increase reactivity and to separate out toxins, hemicellulose and hemicellulose breakdown products which may be inhibitory to downstream hydrolysis or fermentation processes.

Pretreatment of lignocellulosic biomass is projected to be the single, most expensive processing step, representing about 20% of the total cost (65). In addition, the pretreatment type and conditions will have an impact on all other major operations in the overall conversion process from choice of feedstock through to size reduction, hydrolysis, and fermentation as well as on to product recovery, residue processing, and co-product potential. Several methods have been investigated for pretreatment of lignocellulosic materials to produce sugars and/or reactive cellulose. These methods are classified into physical pretreatments, biological pretreatments and physicochemical pretreatments (21, 22). Physical and biological methods alone are not sufficient. Pretreatments that combine both chemical and physical processes are referred to as physicochemical processes (26). These methods are among the most effective and include the most promising processes for industrial applications. Lignin removal and hemicellulose hydrolysis are often nearly complete. Increase in cellulose surface area, decrease in cellulose degrees of polymerization and crystallinity greatly increase overall cellulose reactivity. Treatment rates are usually rapid. The steam explosion process is well documented. Batch and continuous processes were tested at laboratory and pilot scale by several research groups and companies (37, 38). In steam explosion pretreatment, high pressure and hence high temperatures are used i.e. 160 Degrees Celsius to 260 Degrees Celsius for 1 min to 20 min (21, 17-23). The pressure is suddenly reduced, which explosive decompression leads to an explosive decomposition of the materials, leading to defibrization of the lignocellulosic fibers. However, only those pretreatment methods that employ chemicals currently offer the high yields and low costs vital to economic success. Among the most promising are pretreatments using a combination of dilute acid- or sulfur dioxide-catalyzed steam explosion and low molecular weight alcohols.

Steam explosion pretreatment has been successfully applied on a wide range of lignocellulosic biomasses with or without chemical addition (11, 20, 42-44). Acetic acid, dilute sulfuric acid, or sulfur dioxide are the most commonly used chemicals. In the autohydrolysis process, no acid is added as the biomass has a hemicellulose that is high in acetyl groups that are released to form acetic acid during the steaming process. The degree of acetylation of hemicelluloses varies among different sources of biomass. The pretreatment is not effective in dissolving lignin, but it does disrupt the lignin structure and increases the cellulose's susceptibility to enzymatic hydrolysis (11, 38, 45).

The use of liquid ammonia instead of dilute acid effectively reduces the lignin fraction of the lignocellulosic materials (46). However, during ammonia fiber explosion pretreatment (AFEX) a part of the phenolic fragments of lignin and other cell wall extractives remain on the cellulosic surface. AFEX pretreatment does not significantly solubilize hemicellulose if compared to dilute-acid pretreatment. Consequently, hemicellulose and cellulose fractions remain intact and cannot be separated in solid and liquid streams (47). Furthermore, ammonia must be recycled after the pretreatment in order to reduce cost and protect the environment (48).

In the Organosolv process, lignocellulose is mixed with a mixture of organic solvents and water and heated to dissolve the lignin and part of the hemicellulose, leaving reactive cellulose in the solid phase (55, 56). A variety of organic solvents such as alcohols, esters, ketones, glycols, organic acids, phenols, and ethers have been used. For economic reasons, the use of low-molecular-weight alcohols such as ethanol and methanol has been favored (20, 57). A drawback of the Organolsolv process is the presence of hemicellulose with the lignin. An extensive overview of prior art Organosolv processes is given in “Organosolv pulping”—A review and distillation study related to peroxyacid pulping” (58).

In the process patented by Pazner and Chang (59, 60), lignocellulosic biomass is saccharified to convert pentosans and hexosans to sugars by cooking under pressure at from 180 Degrees Celsius to 220 Degrees Celsius with an acetone-water solvent mixture carrying from 0.05 to 0.25% by weight of acid. Whole woody material is nearly dissolved by the process yielding mixed pentoses and hexoses. Delignified pulp is hydrolyzed to glucose monomers that have to be recovered from the liquor.

The Alcell pulping process and further process developments have been applied with limited success on woody biomass (61-64). The problem with these processes is that they result in combined hemicellulose and lignin streams i.e. black liquor that is hard to separate afterwards. Lignin is precipitated from a black liquor produced by pulping wood at high temperatures and pressures with an aqueous lower aliphatic alcohol solvent i.e. lignin is precipitated by diluting the black liquor with water and an acid to form a solution with a pH of less than 3 and an alcohol content of less than 30%.

WO 2008/155639 by Sudakaran et al. describes a two-step pretreatment process, wherein the first stage is an alkaline treatment and the second stage is a dilute acidic treatment. In particular, a first stage aqueous ammonia treatment is disclosed. The main purpose of this process is to remove lignin from the biomass. The goal is to produce a reactive cellulose stream from which lignin has been removed in a first stage by way of an alkaline treatment. This alkaline solution serves to dissolve and remove lignin from the biomass. The dissolved lignin is filtered out of the biomass under pressure and the lignin is recovered from the filtrate by precipitation. The second stage is carried out in dilute sulfuric acid. Sudakaran et al. disclose that Stage 1 of their process is not carried out under explosive conditions and there is no description of any rapid depressurization step, either before or after Stage 2. Therefore, the process of Sudakaran et al. is not a steam explosion pretreatment. The severity of Stage 1 in Sudakaran et al. is higher than in Stage 2 (higher pressure, added acid catalyst) and neither stage is an autohydrolysis step.

WO 2008/137639 by South et al. describes a two-stage pretreatment process for incorporation into the processing of lignocellulosic biomass, but little, if any, characterization of the stages or of the pretreatment method used, is provided. Over 20 different physical, chemical, physiochemical, and biological pretreatment protocols are listed as potential processes, including steam explosion. Steam pressure is identified as the principal pretreatment catalyst. Other pretreatment catalysts like acid and ammonia are identified as optional alternatives to the steam pressure. However, no particular pretreatment protocols are mentioned and in particular no steam explosion protocols. The only particular conditions that are disclosed include a concentrated acid treatment in Stage 1 at low temperature (100-140° C.) for 30-90 minutes and an optionally acidic treatment in Stage 2 at slightly higher temperature (160-220° C.). However, the only variable provided for Stage 2 is temperature. In the absence of time, the actual treatment conditions are impossible to assess. The Examples, which focus on single stage pretreatment processes only, seem to be in direct contrast to the remainder of the description, which focuses on a two-stage pretreatment process. No example of a two stage pretreatment is provided. Moreover, the only condition provided in the Examples is pressure. Example 1 describes a low pressure steam treatment, carried out at 160 psig, and Example 2 describes a high pressure steam treatment, carried out at 250 psig. However, an assessment of the actual treatment conditions, i.e. the severity of the individual treatments, is impossible absent any description of time in the examples. South discloses the use of washing for removing a liquid fraction after Stage 1. Forced removal through compression is not disclosed.

WO2010/071805 by Liu et al. (“Liu”) relates to a method for pre-treating lignocellulosic biomass. Liu teaches a two-step pretreatment process in which two fundamentally different pretreatment processes are run in succession, a low-severity first step (i.e. steam treatment, controlled pH treatment, or autohydrolysis), followed by a liquid hot water (LHW) pretreatment process with dilute acid resulting, at relatively low temperatures, in hemicellulose hydrolysis and lignin solubilisation. Two alternatives for the first stage disclosed in Liu are pH treatment or autohydrolysis. No alternatives for the second stage of LHW pretreatment are disclosed. Liu discloses the need for a second stage operated under mild conditions to avoid the formation of inhibitors of enzymatic and microbial activity. Liu discloses that steam explosion pretreatment is disadvantageous since a significant fraction of the hemicellulos sugars may be damaged by the harsh conditions and that the degradation products produced are inhibitory to downstream processing. Liu further discloses that although acid hydrolysis avoids these problems, it is economically unfeasible and concludes that a combination of steam explosion pretreatment with acid hydrolysis was needed. In the two step process of Liu, which is represented by two different types of pretreatment run in succession, depressurization is logically carried out after the first step, the steam pretreatment step and prior to the second step, the LHW pretreatment step, since LHW cannot be carried out under pressure. Liu disclose acid addition in the second step and teach that hemicellulose hydrolysis occurs in the second stage. Biomass conditioning prior to the two step pretreatment is not disclosed, nor is any liquid extraction between the steps.

Steam explosion pretreatment and LHW pretreatment are fundamentally different pretreatment processes. A breakdown of different hydrothermal treatments, including LHW and steam explosion pretreatments is found in WO2013/131015. Discussions of different LHW processes are found in WO 2012/060767. Combinations of different types of hydrothermal pretreatments, including the combination of steam pretreatment with LHW pretreatment, are discussed in WO2013/148415. The differences between steam pretreatment and LHW pretreatment are discussed in U.S. Pat. No. 5,846,787, WO2011/163137 and in Laser et al. (66).

Laser et al. provide a detailed comparison of LHW pretreatment and steam pretreatment. Steam pretreatment is disclosed to generate a much higher amount of inhibitors than LHW pretreatment. Laser et al. group pretreatment processes into physical, chemical and hydrothermal and hydrothermal treatments are defined as treatments which use water as liquid or vapor. The two principal hydrothermal treatments disclosed are steam pretreatment and LHW pretreatment. Their major distinctions in terms of operation are the water phase used and the solids content of the processed biomass. Steam pretreatment with explosive decompression can produce reactive fiber at solids concentrations of 50% or higher, while LHW pretreatment can only be used to process solids concentrations of 20% or less. It is clear from Laser et al. that steam explosion pretreatment and LHW pretreatment are distinct and separate processes which not only operate at significantly different solids contents, but are significantly different in the amount of inhibitors to downstream fermentation which are produced.

All of the processes described have the challenge of maximizing the yield of glucose, hemicellulose and lignin from biomass, and in general the yield of carbohydrates from lignocellulosic biomass. Thus, an improved pretreatment process is desired.

### SUMMARY OF THE INVENTION

The inventors have now discovered that rather than combining different pretreatment processes for carbohydrate fractionation in multiple pretreatment steps, the use of a single type of pretreatment, steam explosion pretreatment, operated as a two stage process, can be used for improved carbohydrate fractionation, optionally combined with other conventional pretreatment steps.

The present invention relates to a novel method requiring a two-stage steam explosion pretreatment process. This two-stage steam explosion process referred to in the present specification is characterized by a steam stage followed by a steam explosion stage. Each of the two stages of the steam explosion process uses high pressure steam and the biomass is subjected to explosive decompression (i.e. rapid depressurization) at the end of the second stage. Moreover, the first stage is carried out at a lower severity than the second stage. Extraction steps may be incorporated into, or combined with, the two stage steam explosion pretreatment. Extraction of a liquid phase containing hemicellulose sugars may be carried out between the two stages, after the second stage and prior to depressurization and/or after depressurization. However, depressurization of the steam pretreated biomass is always carried out only after the second stage and the second stage is always operated at a higher temperature and pressure than the first stage. This allows for an improved separation of the biomass compounds and breakdown products extracted and in particular an improved carbohydrate fractionation in that extraction of hemicellulose sugars (C5 sugars) separate from cellulose sugars (C6 sugars) is made possible. Furthermore, the addition of a steam conditioning step prior to the two stage steam explosion pretreatment allows for the fractionation of inhibitors contained in the biomass from hemicellulose sugars and cellulose sugars.

In one embodiment, the process in accordance with the invention includes a steam explosion pretreatment process wherein in a first stage biomass is heated to a first stage temperature of 140° C. to 180° C. for a first stage time of 30 minutes to 2 hours at a first stage pressure of 105 to 150 psig; and in a subsequent second stage heated to a second stage temperature of 190° C. to 210° C. for a second stage time of 2 to 10 minutes at a second stage pressure of 167 to 262 psig, the second stage temperature being higher than the first stage temperature and the second stage pressure being higher than the first stage pressure.

Stage 1 may be carried out under mild acidic conditions, either through the use of an external chemical acid catalyst added during the conditioning step or through autohydrolysis in which case the acetic acid is naturally present in the biomass. It is a significant advantage of the present two-stage steam explosion pretreatment process of the invention that additional steps of hemicellulose hydrolysis typically needed downstream from a single stage process, can optionally be reduced or even omitted when the two stage steam explosion pretreatment process is used. In addition, the amount of soluble hemicellulose sugars obtained with the two stage steam pretreatment process is significantly higher than what is achievable with a comparable single stage steam pretreatment process. In addition, the fractionation of the carbohydrates is improved and the ethanol yield from fermentation of the resulting hemicellulose and cellulose component is increased.

Preferably, the process further includes a step of conditioning by atmospheric steam heating and adjusting a moisture content of the biomass prior to the first stage.

The first stage preferably further includes the addition of water, sulfuric acid, sulfur dioxide, acetic acid and/or other acids and a chemical catalyst. Hemicellulose sugars and inhibitors (inhibitory compounds) to downstream hydrolysis and fermentation are preferably removed between the first stage pretreating and the second stage pretreating.

In one embodiment, the first stage pretreating is carried out at a temperature of 140° C. to 170° C. for a time of 50 minutes to 2 hours.

In another embodiment, the second stage pretreating is carried out at a temperature of 200° C. to 210° C. for 3 minutes to 8 minutes.

The removal of hemicellulose sugars and inhibitors to downstream hydrolysis and fermentation is preferably performed by squeezing the biomass in a modular screw device, a screw press or any equivalent device.

In a further embodiment, the process of the invention includes the subsequent step of squeezing the biomass after the second stage pretreatment to further remove hemicellulose sugars and inhibitors to downstream hydrolysis and fermentation.

In yet another embodiment, the first stage temperature is 150° C., the first stage pressure is 105 psig, and the first stage time is 55 min. Preferably, the second stage temperature is 205° C., the second stage pressure is 235psi, and the second stage time is 6.7 minutes.

In still another embodiment, the conditioning step includes heating the biomass with steam at atmospheric pressure for 10 to 60 minutes; squeezing and draining the biomass to remove liquid containing toxins (for example fatty acids, and/or resins) detrimental to downstream hydrolysis and fermentation; adding water and user selected catalyst evenly to adjust the biomass to a water content of 65% to 80% prior to the first stage.

The catalyst is preferably sulfuric acid added at a concentration of between 0.5% to 2% of the weight of the biomass.

In yet a further embodiment, the water content is 70%-75% by weight of the biomass and in the conditioning step the biomass is heated to 90-100° C. for 15 to 30 minutes. Preferably, volatile gasses are released during the step of heating the biomass with steam.in the conditioning step.

### BRIEF DESCRIPTION OF THE DRAWING

FIG. 1 shows an exemplary system to carry out the processes described in this application.

### DETAILED DESCRIPTION OF PREFERRED EMBODIMENTS

Biomass is typically received in a semi-dry state having a moisture content of less than 50% and as low as 10%. For example corncobs usually are obtained after the corn has dried in the field to a moisture content of 15-35%.

Upon arrival at the processing plant the lignocellulose biomass such as wood chips, corn cobs, corn stover, wheat straw, switchgrass, bagasse, miscanthus etc. are chopped to a convenient size. The biomass then has a length of about 1 inch. Water in one embodiment is added to the biomass to improve heat transfer from the steam added in the pre-treatment step.

In an typical process step, the feedstock is pre-steamed at atmospheric pressure for a period of 10 to 60 minutes prior to pretreatment. During the pre-steaming the temperature rises and non-condensable gases such as air are driven off.

The moistened, pre-steamed feedstock can then be pressurized by squeezing it in a screw press or similar device to raise the pressure in one embodiment to that of the pre-treatment process, 1^{st} stage. During the squeezing process, some of the liquid is removed along with extractable compounds such as fatty acids, tall oils and resins that adversely affect downstream processing.

The biomass then goes through the first stage of pretreatment for where high pressure steam is typically used to raise the temperature to 140-180 degrees Celsius and held for the equivalent of 30-120 minutes.

After this first stage pretreatment the biomass still under pressure is washed and squeezed to remove the solublized hemicellulose rich fraction which is inhibitory to downstream processes. It is then fed into a second phase of pretreatment where high pressure steam is used to raise the temperature to 190-210 Degrees Celcius for 2-8 minutes after which it is depressurized rapidly and moved on to downstream processing typically enzyme hydrolysis.

After the second pretreatment step before depressurization the biomass optionally may undergo a second water washing and squeezing step.

The depressurized purified cellulose stream is prepared for downstream processing such as enzyme hydrolysis and fermentation to ethanol.

The solubilized hemicellulose washing stream was found to not require further hydrolysis or less than that of a single stage process and can be concentrated and then fed directly into a downstream process such as fermentation to ethanol more preferably co-fermented with the cellulose hydrolysate.

Overall it is was found that using a 2 step pretreatment process was advantageous over a single step process as it recovered more hemicellulose sugars and required less post processing on the hemicellulose sugars.

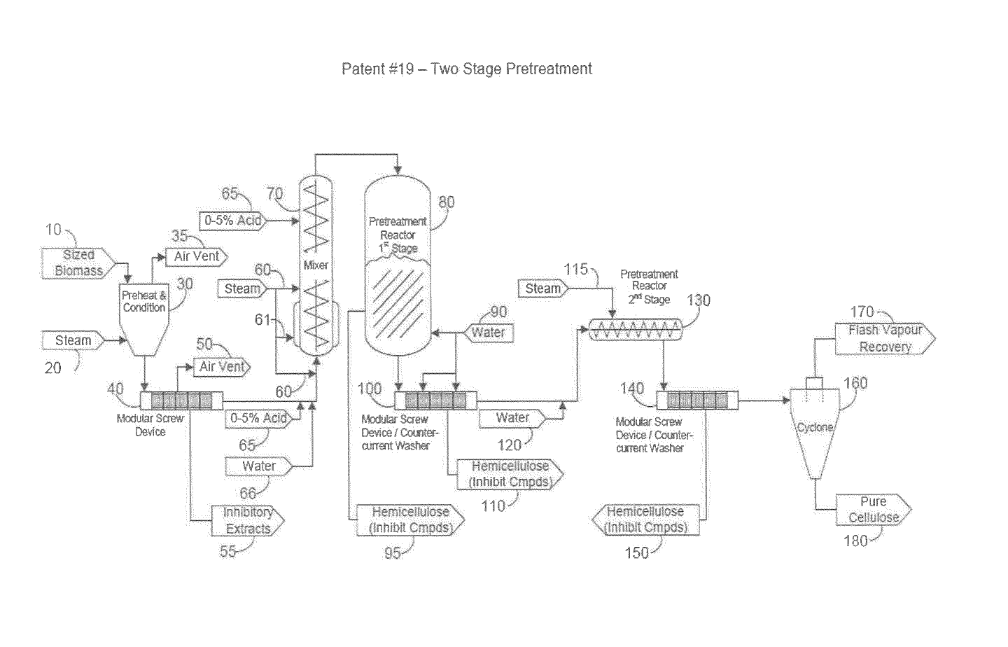

For example, as shown in FIG. 1, sized biomass 10 is conveyed into a steaming bin or container 30. Biomass is typically received for processing in a semi-dry state having moisture content of less than 50%, and as low as 10%. For example corncobs usually are obtained after the corn has dried in the field to a moisture content of 15-35%. Upon arrival at the processing plant, the biomass, such as corncobs, is chopped to a convenient size. The biomass is typically chopped to a length of about 1 inch. Water can be added to the sized biomass to raise moisture content prior to steam heating step in the conditioning process.

Steam 20 is injected proximate to a bottom of the container at one or more spots to heat the sized biomass 10. Air, steam, and non-condensable gases are vented from a vent 35 proximate to a top of the container 30. As the steam 20 drives heat up the container 30, the sized biomass 10 absorbs moisture and becomes evenly charged with moisture. During the steaming, the temperature rises and non-condensable gases are driven off. In one embodiment, the sized biomass 10 is heated to 80 to 100 Degrees Celsius with steam at atmospheric pressure for a period of 10 to 60 minutes. In one embodiment more preferably 90-99 degrees Celsius.

Steam heated biomass is drawn from the bottom of the container 30 and is fed to any type of compression or squeezing device 40 such as a screw press, modular screw device (MSD), etc. It is contemplated that any device that squeezes or compresses biomass could be used to compress the biomass and drain extracted fluids. In one embodiment, the squeezing device 40 squeezes the steam heated biomass with a 2-1 to 6-1 compression ratio, and most preferably 4-1. The squeezing device 40 has a vent 50 to vent gases if necessary, and a drain 55 to drain inhibitory extracts which are squeezed from the steam heated biomass. During the squeezing process, a portion of the liquid is removed from the steam heated biomass along with compounds that adversely affect downstream processing steps in the manufacture of ethanol such as resins, tall oils and fatty acids. These compounds are also adverse to other processes.

Squeezed biomass 45 is then fed to a mixing device 70. The mixing device 70 mixes the squeezed biomass 45 with the optional addition of water through a water inlet 66 and/or optional addition of catalyst through a catalyst inlet 65. In one embodiment, the catalyst is acid and may range in concentration from between 0 and 5% by volume and the biomass water content ranges from 60% to 80% by weight. In one embodiment, this mixing step can be incorporated right on the discharge of the squeezing device 40. A suitable mixing device 70 in one instance could be as simple as one or more injection or addition points along the outlet of the squeezing device 40. This is operable because the squeezed biomass 45 is similar to a squeezed sponge and It can readily and actively absorb the water and chemicals. In a preferred embodiment of the mixing step, water and/or water and catalyst such as sulfuric acid are added to bring the moisture content to greater than 65%.

The conditioned biomass then discharges into the 1^{st} stage pretreatment reactor 80 The biomass is treated in the 1^{st} stage pre-treatment reactor 80 at a temperature of 140 to 180° C., at a pressure of 105 to 150 psig for a time of 30 to 120 minutes depending on biomass feedstocks, the pressure is regulated by a valve and is typically held higher than the steam table as the biomass releases gasses during pretreatment. Optionally, water 90 is added to the 1^{st} stage pre-treatment reactor 80. Hemicellulose and inhibitory compounds detrimental to downstream hydrolysis and fermentation 95 can be optionally removed from the 1^{st} stage pre-treatment reactor 80, for example as described in United States Patent Application Publication No. 2010/0263814, titled “Pretreatment of Lignocellulosic Biomass Through Removal of Inhibitory Compounds”, which is incorporated herein by reference.

After treatment in the 1^{st} stage pre-treatment reactor 80, the partially pretreated biomass is fed to a compressing extraction device such as screw press, modular screw device or counter-current washer 100 with the optional addition of water 90. Inhibitors such as Hemicellulose and other soluble compounds that are inhibitory to downstream processing such as ethanol fermentation can be removed through a drain 110.

The partially treated biomass is then discharged into a tank for subsequent hydrolysis etc. or fed to a 2^{nd} stage pretreatment reactor 130. The 2^{nd} stage pretreatment reactor 130 is at a temperature of 190 to 210° C., and a pressure of 167 to 262 psig for a time of 2 to 8 minutes by using high pressure steam at 115 In a optional embodiment, depending on the type of equipment utilized and the biomass type pre-treated biomass is then discharged to another compressing extraction device such as modular screw device, screw press or counter-current washer 140, and optionally hemicellulose and other soluble compounds that are inhibitory to downstream hydrolysis and fermentation are removed through a drain 150.

The pre-treated biomass is then discharged through a pressure reducing device to a cyclone 160. Purified cellulose is removed from the bottom of the cyclone 180, and flash steam vapors can be recovered from the top outlet 170.

The following examples show the increase in the recovery of soluble hemicellulose sugars using the novel two stage pretreatment process as well as the improvement in ethanol yield when both hemicellulose and cellulose are used to make ethanol.

### EXAMPLES

### Example 1-2

### Stage Dilute Acid Pretreatment

Corncobs were chopped, moistened and conditioned using steam to preheat, adjust moisture, and to remove air and other non-condensable gases. Sulfuric acid was added in the amount of 0.8%. The conditioned, acidified cobs were pretreated at a temperature of 150° C. for 55 minutes using high pressure steam. The cobs were then washed with water to remove a hemicellulose sugars rich stream (solid liquid separation) and then subjected to a second pretreatment at a temperature of 205° C. for 6.7 minutes. The cellulose solids were hydrolyzed and then co-fermented with the hemicellulose stream into ethanol.

### Example 2

### Single Stage Dilute Acid

Corncobs were chopped, moistened and conditioned using steam to preheat, adjust moisture, and to remove air and other non-condensable gases. Sulfuric acid was added in the amount of 0.8%. The conditioned, acidified cobs were pretreated at a temperature of 150° C. for 120 minutes using high pressure steam. The cobs were then washed. The cellulose solids and hemicellulose sugars stream were hydrolyzed and co-fermented into ethanol.

The yield of soluble hemicellulose monomers (XMG) was 79% for the 2-stage dilute acid, example 1, an increase of 11 percentage points over the single stage process, example 2. Both cellulose and hemicellulose sugars streams were fermented to ethanol. The overall yield of ethanol increased from 316 to 321 litres per tonne for the 2-stage process over the single. As seen at chart 1, the 2-stage process in example 1, did not require a hemicellulose hydrolysis step as the single stage. In example 2, a processing benefit can be realized by alternatively adding the hemicellulose hydrolysis step to the 2-stage process which would have further increased the ethanol yield over the single step.

### Example 3-2

### Stage Autohydrolysis

Corncobs were chopped, moistened and conditioned using steam to preheat, adjust moisture, and to remove air and other non-condensable gases. The conditioned cobs were pretreated at a temperature of 150° C. for 55 minutes using high pressure steam. The cobs were then washed with water to remove a hemicellulose sugars rich stream (solid liquid separation) then subjected to a second pretreatment at a temperature of 205° C. for 6.7 minutes. The cellulose solids were hydrolyzed and then co-fermented with the hemicellulose stream into ethanol.

### Example 4

### Single Stage Autohydrolysis

Corncobs were chopped, moistened and conditioned using steam to preheat, adjust moisture, and to remove air and other non-condensable gases. The conditioned cobs were pretreated at a temperature of 205° C. for 8 minutes using high pressure steam. The cobs were then washed. The cellulose solids and hemicellulose stream were hydrolyzed and co-fermented into ethanol.

The yield of soluble hemicellulose sugar monomers (XMG) was 75% in the 2-stage, example 3. This was an increase of 14 percentage points over a single stage process in example 4. The overall yield of ethanol increased from 308 to 317 litres per tonne for the 2-stage process over the single stage. As seen in chart 1, the 2-stage process in example 3 did not require a hemicellulose hydrolysis step as required in the single stage processing example 4. A processing benefit can be realized by alternatively adding the hemicellulose hydrolysis step to the 2-stage as this would have further increased the ethanol yield over the single step.

CHART 1
Results of Examples 1-4

| | | Single stage pre-treatment | | Two-stage pre-treatment | |
|---|---|---|---|---|---|
| Incoming Carbohydrates kg per | | Example 4 | Example 2 | Example 3 | Example 1 |
| mtdm Glucose 400, | | Single Stage | Single Stage | 2-stage | 2-stage |
| Xylose/Mannose/Galactose 300 | | Autohydrolysis | Dilute Acid | Autohydrolysis | Dilute Acid |
| Pre- | Total Glucose | 99 | 99 | 98 | 98 |
| treatment | Total Hemicellulose | 74 | 80 | 82 | 85 |
| Recovery | Sugars | | | | |
| (%) | Soluble Hemicellulose | 61 | 68 | 75 | 79 |
| | Sugars | | | | |

| | | | | |
|---|---|---|---|---|
| Ethanol Yield (%, per mtdm) | 308 | 316 | 317 | 321 |

CHART 2
Single Stage Autohydrolysis and two-stage pre-treatment of poplar

| | | | | | Single stage | Two-stage |
|---|---|---|---|---|---|---|
| Process | | Line # | Parameters | (Units) | Values | |
| Feedstock | Wood chips | 1 | Poplar | (kg DM) | 1000 | |
| | Composition | 2 | Glucose | (Kg/MTDM incoming poplar) | 475 | |
| | | 3 | Hemicellulose | (Kg/MTDM incoming poplar) | 216 | |
| | | 4 | Xylose | (Kg/MTDM incoming poplar) | 184 | |
| | | 5 | Other compounds (e.g. Lignin, extractives) | (Kg/MTDM incoming poplar) | 309 | |
| Conditioning | Steps | 6 | Steaming | Time (min)/Temperature (° C. [symbol] | 60/100 | |
| | | 7 | Squeezing | (compression ratio) | 3.5:1 | |
| | | 8 | Moisture adjustment | (% moisture) | 70 | |
| Pre- | Pre- | 11 | Cooking time | (min) | 60 | 7.50 |
| treatment | treatment | 12 | Temperature | (° C.) | 170 | 170/205 |
| | conditions | 13 | Pressure | (psi) | 100 | 100/235 |
| | | 14 | Acid load | (% DM on poplar) | 0 | 0/0.13 |
| | | 15 | pH | (pH value) | 3.6 | 3.6/2.0 |
| | Cellulose | 16 | Total recovered glucose | (% of incoming) | 99.6 | 99.0 |
| | (as glucose) | 17 | Total recovered glucose | (Kg/MTDM incoming poplar) | 473 | 470 |
| | | 18 | Soluble glucose | (% of incoming) | 1.4 | 3.2 |
| | | 19 | Soluble glucose | (Kg/MTDM incoming poplar) | 6 | 15 |
| | | 20 | Insoluble glucose | (% of incoming) | 98.3 | 95.8 |
| | | 21 | Insoluble glucose | (Kg/MTDM incoming poplar) | 467 | 455 |
| | Hemi- | 22 | Total recovered hemicellulose | (% of incoming) | 93.0 | 87.1 |
| | cellulose | 23 | Total recovered hemicellulose | (Kg/MTDM incoming poplar) | 201 | 188 |
| | | 24 | Soluble hemicellulose | (% of incoming) | 59.3 | 70.4 |
| | | 25 | Soluble hemicellulose | (Kg/MTDM incoming poplar) | 128 | 152 |
| | | 26 | Hemicellulose monomers | (Kg/MTDM incoming poplar) | 23 | 28 |
| | | 27 | Insolube hemicellulose | (% of incoming) | 33.7 | 16.7 |
| | | 28 | Insolube hemicellulose | (Kg/MTDM incoming poplar) | 73 | 36 |
| | Xylose | 29 | Total recovered xylose | (% of incoming) | 92.5 | 87.2 |
| | | 30 | Total recovered xylose | (Kg/MTDM incoming poplar) | 170 | 160 |
| | | 31 | Soluble xylose | (% of incoming) | 60.9 | 74.2 |
| | | 32 | Soluble xylose | (Kg/MTDM incoming poplar) | 112 | 137 |
| | | 33 | Xylose monomers | (Kg/MTDM incoming poplar) | 18 | 24 |
| | | 34 | Insolube xylose | (% of incoming) | 31.6 | 13.0 |
| | | 35 | Insolube xylose | (Kg/MTDM incoming poplar) | 58 | 24 |
| Hydrolysis | Cellulose | 36 | Hydrolysis of Cellulose prehydrolysate - 17% consistency, 120 h, 0.57% DM cellulases on poplar | | | |
| | (C6) stream | 37 | Conversion to glucose monomers | (% of insoluble glucose) | 73.6 | 90.5 |
| | | 38 | Soluble glucose monomers | (Kg/MTDM incoming poplar) | 344 | 412 |
| | | 39 | Conversion to xylose monomers | (% of insoluble xylose) | 71.6 | 94.7 |
| | | 40 | Soluble xylose monomers | (Kg/MTDM incoming poplar) | 42 | 23 |
| | Hemi- | 41 | Post-hydrolysis of Hemicellulose prehydrolysates - 13% consistencyc, 4 h, pH 2 (Sulphuric acid) | | | |
| | cellulose | 42 | Conversion to glucose monomers | (% of soluble glucose) | 65 | 53 |
| | (C5) stream | 43 | Soluble glucose monomers | (Kg/MTDM incoming poplar) | 4 | 8 |
| | | 44 | Conversion to xylose monomers | (% of soluble xylose) | 96 | 95 |
| | | 45 | Soluble xylose monomers | (Kg/MTDM incoming poplar) | 108 | 130 |
| Fermentation | C5-C6 co- | 46 | Monomers (C5 & C6) available for Co-fermentation (48 h, 1gpl DM of propagated C5-C6 yeast) | | | |
| | fermentation | 47 | Total C5-C6 monomers | (Kg/MTDM incoming poplar) | 497 | 572 |
| | | 48 | Glucose monomers | (Kg/MTDM incoming poplar) | 348 | 420 |
| | | 49 | Xylose monomers | (Kg/MTDM incoming poplar) | 149 | 152 |
| | | 50 | Fermentation yield | (% of Theoretical Maximum) | 91 | 91 |

| | | | | | |
|---|---|---|---|---|---|
| Ethanol distillation/dehydr [symbol] | 51 | Ethanol production | (L/MTDM incoming poplar) | 292 | 336 |

[symbol]

indicates data missing or illegible when filed

CHART 3
Detailed Conditions of Examples 1-4

| | Particle size reduction (0.3-3 cm), Moisture adjustment 50-80%, | | | |
|---|---|---|---|---|
| | 10-60 min pre-steaming at 90-100 Degrees Celsius | | | |
| | Single stage pre-treatment | | Two-stage pre-treatment | |
| Biomass Conditioning all | Example 4 | Example 2 | Example 3 | Example 1 |
| examples | Single Stage | Single Stage | 2-Stage | 2-Stage Dilute |
| Pre-treatment Example | Autohydrolysis | Dilute Acid | Autohydrolysis | Acid |

Pre-treatment conditions

| | | | | | |
|---|---|---|---|---|---|
| Stage #1 | Temperature (° C.) | 205 | 150 | 150 | |
| | Pressure (psig) | 235 | 54 | 54 | |
| | Time (min) | 8 | 120 | 55 | |
| | H₂SO₄ (%, w/w dm) | 0 | 0.8 | 0 | 0.8 |
| | pH post pre-treatment | 3.8 | 2.0 | 3.8 | 2.0 |

| | | |
|---|---|---|
| Stage #2 | Temperature (° C.) | 205 |
| | Pressure (psig) | 235 |
| | Time (min) | 6.7 |
| | Acid (%, w/w dm) | 0 |
| | pH post pre-treatment | 4.4 |

| | | | | |
|---|---|---|---|---|
| Hemicellulose stream post-hydrolysis | Yes | No | Yes | No |
| (enzymatic or dilute acid) | | | | |

### Example 5

### Single Stage Autohydrolysis and Two-Stage Pre-Treatment of Poplar

Poplar wood chips were moistened, squeezed to remove extractives and further conditioned using steam to preheat, adjust moisture, and to remove air and other non-condensable gases (Chart 2—Line #6-8). The conditioned poplar chips were pretreated at a temperature of either 170° C. for 60 minutes under standard pulp and paper autohydrolysis conditions (Single stage) or 170° C. for 60 minutes (first stage) followed by a second stage carried out at 205° C. for 8 minutes using high pressure steam in presence of dilute acid catalyst to adjust pH value to pH 2.0 (Chart 2—Line #11-15). The prehydrolysed poplar chips were washed after the single or first stage pre-treatment. The cellulose solids and hemicellulose stream were analyzed (Chart 2—Line #16-35), hydrolyzed (Chart 2—Line #36-45) and co-fermented into ethanol (Chart 2—Line #46-50).

If compared to the standard pulp and paper single stage autohydrolysis pretreatment, the two stage pre-treatment led to a substantial increase in the yields of
(i) soluble monomers and oligomers hemicellulose sugars (Chart 2—Line #24-26),
(ii) xylose oligomers and monomers (Chart 2—Line #24-26, 45, 49),
(iii) glucose monomers (Chart 2—Line #38) that results from an improved digestibility of the cellulose fibers (Chart 2—Line #37), and thus
(iv) ethanol (i.e. +15%) on a dry matter basis of incoming poplar chips (Chart 2—Line #51).

The above-described embodiments are intended to be examples only. Alterations, modifications and variations can be effected to the particular embodiments by those of skill in the art without departing from the scope, which is defined solely by the claims appended hereto.

### NON-PATENT REFERENCES

(1) Shapouri H et al. (1995) USDA Report 721. Estimating the net energy balance of corn ethanol.
(2) Shapouri H et al. (2002) USDA Report 813. The Energy Balance of corn ethanol: an update.
(3) Chow J et al. (2003) Science, 302, 1528-1531 Energy resources and global development.
(4) Wald M L, Barrionuevo A (2007) New York Times, April 7th, The Energy challenge: A Renewed push for ethanol, without the corn.
(5) Greeg D (2008) Biocycle, 49, 11-47. Commercializing cellulosic ethanol.
(6) Hill J et al. (2006) Proc. Natl. Acad. Sci. USA, 103, 11206-11210. Environmental, economic, and energetic costs and benefits of biodiesel and ethanol biofuels.
(7) Farrell A E et al. (2006) Science, 311, 506-508. Ethanol can contribute to energy and environmental goals.
(8) Somerville C (2007) Current biology, 17, 115-119. Biofuels.
(9) Schuetzle D et al. (2007) Western Governors' Association. Alcohol fuels from biomass-Assessment of production technologies.
(10) Chum L, Overend R (2002) Fuel Processing technology, 71, 187-195. Biomass and renewable fuels.
(11) Wyman C E (1996) Taylor & Francis: Washington D.C., USA, Handbook on bioethanol: production and utilization.
(12) Delmer D P, Amor Y (1995) Plant Cell, 7, 987-1000. Cellulose biosynthesis.
(13) Morohoshi N (1991) In Wood and cellulosic chemistry; Hon, D. N. S, Shiraishi, N., Eds.; Marcel Dekker, Inc.: New York, USA, Chemical characterization of wood and its components.
(14) Ha M A et al. (1998) Plant J. 1998, 16, 183-190. Fine structure in cellulose microfibrils: NMR evidence from onion and quince.
(15) Palmqvist E, Hahn-Hagerdal B (2000) Bioresource Technol., 74, 25-33. Fermentation of lignocellulosic hydrolysates. II: Inhibitors and mechanisms of inhibition.
(16) De Vrije T et al (2002) International journal of hydrogen energy, 27, 1381-1390. Pretreatment of miscanthus for hydrolgen production by thermotoga elfii.
(17) Galbe M, Zacchi G (2002) Appl Microbiol Biotechnol 59 618-628. A review of the production of ethanol from softwood.
(18) Torget R et al. (1991) Bioresource Technol., 35, 239-246. Dilute sulfuric acid pretreatment of hardwood bark.
(19) Donghai Set al. (2006) Chinese J. Chem. Eng., 14, 796-801. Effects of different pretreatment modes on the enzymatic digestibility of corn leaf and corn stalk.
(20) Sun Y, Cheng J (2002) Bioresources Technol., 83, 1-11. Hydrolysis of lignocellulosic materials for ethanol production: A review.
(21) McMillan J D (1994) In Enzymatic Conversion of Biomass for Fuels Production; Himmel, M. E., Baker, J. O., Overend, R. P., Eds.; ACS: Washington D.C., USA, 1994; pp. 292-324. Pretreatment of lignocellulosic biomass.
(22) Fan L et al (1982) Adv. Biochem. Eng. Biotechnol., 23, 158-183. The nature of lignocellulosics and their pretreatments for enzymatic hydrolysis.
(23) Mosier N et al. (2005) Bioresources Technol, 96, 673-686. Features of promising technologies for pretreatment of lignocellulosic biomass.
(24) Henley R G et al. (1980) Enzyme Microb. Tech., 2, 206-208. Enzymatic saccharification of cellulose in membrane reactors.
(25) Berlin A et al. (2006) J. Biotechnol., 125, 198-209. Inhibition of cellulase, xylanase and beta-glucosidase activities by softwood lignin preparations.
(26) Chandra R et al. (2007) Adv. Biochem. Eng. Biotechnol, 108, 67-93.Substrate pretreatment: The key to effective enzymatic hydrolysis of lignocellulosics?
(27) Kassim E A, EI-Shahed A S (1986) Agr. Wastes, 17, 229-233. Enzymatic and chemical hydrolysis of certain cellulosic materials.
(28) Xu Z et al (2007) Biomass Bioenerg. 2007, 31, 162-167. Enzymatic hydrolysis of pretreated soybean straw.
(29) Vaccarino C et al (1987) Biol. Waste, 20, 79-88. Effect of SO2NaOH and Na2CO3 pretreatments on the degradability and cellulase digestibility of grape marc.
(30) Silverstein R A et al (2007) Bioresource Technol,. 2007, 98, 3000-3011.A comparison of chemical pretreatment methods for improving saccharification of cotton stalks.
(31) Zhao X et al (2007) Bioresource Technol., 99, 3729-3736. Comparative study on chemical pretreatment methods for improving enzymatic digestibility of crofton weed stem.
(32) Gaspar M et al (2007) Process Biochem., 2007, 42, 1135-1139. Corn fiber as a raw material for hemicellulose and ethanol production.
(33) Saha B C, Cotta M A (2006) Biotechnol. Progr., 22, 449-453. Ethanol production from alkaline peroxide pretreated enzymatically saccharified wheat straw.
(34) Saha B C, Cotta M A (2007) Enzyme Microb. Tech., 41, 528-532. Enzymatic saccharification and fermentation of alkaline peroxide pretreated rice hulls to ethanol.
(35) Mishima D et al (2006) Bioresource Technol. 2006, 97, 2166-2172.Comparative study on chemical pretreatments to accelerate enzymatic hydrolysis of aquatic macrophyte biomass used in water purification processes.
(36) Sun X F et al (2005) Carbohyd. Res., 340, 97-106. Characteristics of degraded cellulose obtained from steam-exploded wheat straw.
(37) Chum H L (1985) Solar Energy Research Institute: Golden, Colorado, 1-64. Evaluation of pretreatments of biomass for enzymatic hydrolysis of cellulose.
(38) Taherzadeh M J, Karimi K (2007) Bioressources, 2, 472-499. Process for ethanol from lignocellulosic materials I: Acid-based hydrolysis processes.
(39) Ruiz E et al (2008) Enzyme Microb. Tech., 42, 160-166. Evaluation of steam explosion pretreatment for enzymatic hydrolysis of sunflower stalks.
(40) Ballesteros M et al. (2004) Process Biochem., 39, 1843-1848. Ethanol from lignocellulosic materials by a simultaneous saccharification and fermentation process (SFS) with Kluyveromyces marxianus CECT 10875.
(41) Negro M J et al (2003) Appl. Biochem. Biotechnol., 105, 87-100. Hydrothermal pretreatment conditions to enhance ethanol production from poplar biomass.
(42) Kurabi A et al (2005) Appl. Biochem. Biotechnol., 121-124. Enzymatic hydrolysis of steam exploded and ethanol organosolv-pretreated Douglas-firby novel and commercial fungal cellulases.
(43) Varga E et al (2004) Appl. Biochem. Biotechnol., 509-523. Optimization of steam pretreatment of corn stover to enhance enzymatic digestibility.
(44) Eklund R (1995) Bioresource Technol., 52, 225-229. The influence of SO2 and H2SO4 impregnation of willow prior to steam pretreatment.
(45) Yang B, Wyman C E (2004) Biotechnol. Bioeng, 86, 88-95. Effect of xylan and lignin removal by batch and flowthrough pretreatment on the enzymatic digestibility of corn stover cellulose.
(46) Alizadeh H et al (2005) Appl. Biochem. Biotechnol., 124, 1133-41. Pretreatment of switchgrass by ammonia fiber explosion (AFEX).
(47) Chundawat S P et al (2007) Biotechnol. Bioeng., 96, 219-231. Effect of particle size based separation of milled corn stover on AFEX pretreatment and enzymatic digestibility.
(48) Eggeman T, Elander R T. (2005) Bioresource Technol., 96, 2019-2025. Process and economic analysis of pretreatment technologies.
(49) Taherzadeh M J, Karimi K (2007) BioResources, 2, 707-738. Enzymatic-based hydrolysis processes for ethanol from lignocellulosic materials: A review.
(50) Neely W C (1984) Biotechnol. Bioeng., 26, 59-65. Factors affecting the pretreatment of biomass with gaseous ozone.
(51) Vidal P F, Molinier J (1988) Biomass, 16, 1-17. Ozonolysis of Lignin—Improvement of in vitro digestibility of poplar sawdust.
(52) Azzam AM (1989) J. Environ. Sci. Heal., 24, 421-433. Pretreatment of cane bagasse with alkaline hydrogen peroxide for enzymatic hydrolysis of cellulose and ethanol fermentation.
(53) Katzen R et al (1995) In The Alcohols Textbook; Lyons, T. P., Murtagh, J. E., Kelsall, D. R., Eds.; Nothingham University Press, 37-46. Use of cellulosic feedstocks for alcohol production.
(54) Araque E et al (2007) Enzyme Microb.Tech., 43, 214-219. Evaluation of organosolv pretreatment for the conversion of Pinus radiata D. Don to ethanol.
(55) Itoh H et al (2003) J. Biotechnol., 103, 273-280. Bioorganosolve pretreatments for simultaneous saccharification and fermentation of beech wood by ethanolysis and white rot fungi.
(56) Pan X et al (2006) Biotechnol. Bioeng., 94, 851-861. Bioconversion of hybrid poplar to ethanol and co-products using an organosolv fractionation process: optimization of process yields.
(57) Arato C et al (2005) Appl. Biochem. Biotechnol. 2005, 123, 871-882. The lignol approach to biorefining of woody biomass to produce ethanol and chemicals.
(58) Muurinen E (2000) University of Oulu, Finland, ISBN 951-42-5661-1. Organosolv pulping-A review and distillation study related to peroxyacid pulping. http://herkules.oulu.fi/isbn9514256611/isbn9514256611.pdf
(59) Pasner L, Chang P C (1983) U.S. Pat. No. 4,409,032
(60) Pasner L, Chang P C (1984) US Pat. No. 4,470,851
(61) Lora J H et al (1988) U.S. Pat. No. 4764,596, International publication WO 93/15261
(62) Van Heiningen A R P (1996) U.S. Pat. No. 08/621,5096, International publication WO 97/36040
(63) Pye E K (2002) US patent #2002/0069987
(64) Petrus L (2007) US patent #2007/0034345 A
(65) Yang B, Wyman C E (2007) Biofuels, Bioproducts and Biorefinering, 2, 26-40. Pretreatment: the key to unlocking low-cost cellulosic ethanol
(66) Laser et al. (Bioresource Technology 81(2002) 33-44).

What is claimed is:

1. A pretreatment process for the fractionation of carbohydrates from lignocellulosic biomass, comprising:
a) conditioning the biomass by atmospheric steam heating to adjust a moisture content of the biomass and generate a conditioned biomass;
b) subjecting the conditioned biomass to high pressure steam pretreatment to obtain steam pretreated biomass;
c) rapidly depressurizing the steam pretreated biomass to obtain pretreated biomass; and
d) separating hemicellulose sugars from the pretreated biomass;
wherein the high pressure steam pretreatment is a two stage high pressure steam pretreatment including
i) pretreating the biomass in a first stage at a first severity by heating the biomass to a first stage temperature of 140° C. to 180° C. at a first stage pressure of 105 to 150 psig and for a first stage time of 30 minutes to 2 hours; and
ii) pretreating the biomass in a second stage at a second severity higher than the first severity by heating the biomass to a second stage temperature of 190° C. to 210° C., at a second stage pressure of 167 to 262 psig, and for a second stage time of 2 to 10 minutes.

2. The process of claim 1, wherein the conditioning step further comprises the addition of water and a catalyst.

3. The process of claim 1, wherein the first stage pretreating further comprises the addition of water and at least one of an acid promoting hemicellulose hydrolysis, sulfuric acid, sulfur dioxide, acetic acid and a chemical catalyst promoting hemicellulose hydrolysis.

4. The process of claim 1, further comprising the step of removing hemicellulose and inhibitors to downstream hydrolysis or fermentation between the first stage pretreating and the second stage pretreating.

5. The process of claim 1, wherein the first stage pretreating is carried out at a temperature of 140° C. to 170° C. for a time of 50 minutes to 2 hours.

6. The process of claim 1, wherein the second stage pretreating is carried out at a temperature of 200° C. to 210° C. for 3 to 8 minutes.

7. The process of claim 1, further comprising one or both of the steps of removing hemicellulose and inhibitors to downstream hydrolysis or fermentation by squeezing the steam pretreated biomass in a modular screw device, a screw press or equivalent device prior to the depressurizing; and removing hemicellulose and inhibitors to downstream hydrolysis or fermentation by squeezing the pretreated biomass in a modular screw device, a screw press or equivalent device after the depressurizing.

8. The process of claim 4, further comprising a subsequent step of squeezing the biomass after the second stage pretreating to further remove hemicellulose and inhibitors to downstream hydrolysis and fermentation.

9. The process of claim 1, wherein the first stage temperature is 150° C., the first stage pressure is 105 psig, and the first stage time is 55 min.

10. The process of claim 1, wherein the second stage temperature is 205° C., the second stage pressure is 235psi, and the second stage time is 6.7 minutes.

11. The process of claim 2, wherein the conditioning step comprises: heating the biomass with steam at atmospheric pressure for 10 to 60 minutes; squeezing and draining the biomass to remove liquid containing toxins detrimental to downstream hydrolysis and fermentation; and
evenly adding the water and a catalyst promoting hemicellulose hydrolysis to adjust the biomass to a water content of 65% to 80% prior to the first stage.

12. The process of claim 11, wherein the toxins comprise fatty acids, and/or resins.

13. The process of claim 11, wherein the catalyst is sulfuric acid which is added at a concentration of from 0.15% to 2% of the weight of the biomass.

14. The process of claim 11, wherein the water content is 70%-75% by weight of the biomass.

15. The process of claim 11, wherein in the conditioning step the biomass is heated to 90-100° C. for 15 to 30 minutes.

16. The process of claim 11, wherein during the conditioning step, volatile gasses are released during the step of heating the biomass with steam.

17. The process of claim 1, wherein the second stage temperature is 205° C., the second stage pressure is 235 psig, and the second stage time is 6.7 minutes.
